(19) United States
(12) Patent Application Publication
(10) Pub. No.: US 2001/0045206 A1
(43) Pub. Date: Nov. 29, 2001

(54) Air/fuel module with integrated components and electronics

(76) Inventors: Daniel F. Smith, Conesus, NY (US); William P. Whitlock, Cicero, IN (US); Daniel A. Lawlyes, Kokomo, IN (US); Keith A. Confer, Flushing, MI (US); Curtis D. Lamb, Scottsville, NY (US)

Correspondence Address: Delphi Technologies, Inc., P.O. Box 5052, Mail Code 480414420, Troy, MI, 18007, US

(21) Appl. No.: 09/851,854

(22) Filed: May 9, 2001

Related U.S. Application Data
(60) Provisional application No. 60/202,785, filed on May 9, 2000.

(51) Int. Cl. F01P 1/06; F02M 51/00

(52) U.S. Cl. 123/478; 123/41.31

(57) ABSTRACT

An air/fuel intake manifold module having fuel injectors and having an electronic engine control module (ECM) cooled by the passage of air through the manifold. The ECM is protected from contamination and damage by a coating. The ECM may be mounted in the air flow path immediately ahead of the main engine throttle body, or in a well formed in a wall of the manifold. The ECM in the well may be further cooled by placement of a heat-sink between the ECM and the manifold or by fins extended through the manifold wall into the air stream within the manifold. Alternatively, the ECM circuit board itself may be extended through a slot in the manifold wall into the air stream, or the circuits may be applied to, or formed directly on, an interior or exterior surface of the manifold. Lead wires may be cast into the manifold wall to eliminate the need for a wiring harness, such that control circuits are automatically formed when the fuel injectors and ECM are installed onto the manifold, thus forming an integrated air/fuel manifold module.

### CROSS-REFERENCE TO RELATED APPLICATIONS

This application is a conversion of a U.S. Provisional application, Ser. No. 60/202,785, filed May 9, 2000 and claims priority from that date.

### TECHNICAL FIELD

The present invention relates to air/fuel supply systems for internal combustion engines; more particularly, to such systems wherein the electromechanical action is controlled by an electronic engine control module (ECM); and most particularly, to air/fuel intake manifold modules wherein the ECM is physically incorporated into the manifold and is cooled by air passing through the manifold.

### BACKGROUND OF THE INVENTION

Internal combustion engines for vehicles are provided with an intake manifold having a plurality of internal passageways, of “legs,” each leading from a common air entry port in a throttle body to an intake valve for a firing chamber. In fuel-injected engines, during each engine cycle a metered amount of fuel is injected at some point within the manifold, either in a single common injection near the throttle, or more commonly just ahead of each intake valve. The timing of the injections, as well as control of other electrical components was achieved in the past by a master vehicle ECM mounted typically on the vehicle remote from the manifold and connected to the injectors and other electrical components, during assembly of the engine or vehicle, by the vehicle's wiring harness. More recently, an ECM containing this control logic has been mounted typically at a site on or near the manifold. This ECM is integrated into the rest of the engine and vehicle operating logic via pin connectors to the vehicle's wiring harness, and also is connected to the injectors and other electrical components by a sub-harness disposed on the manifold. This arrangement allows the manifold to be pre-assembled and tested as an air/fuel module which is then assemblable to an engine with a minimum of parts, labor, and testing. The module may even be produced by an outside vendor and supplied to a vehicle manufacturer.

A serious problem can arise, however, in configuring such modules. The presence of the ECM on the manifold exposes the circuit board to the operating temperature of the engine, which can readily attain or even exceed 120° C. In addition, the components of an ECM may generate significant operating heat themselves. High temperatures are known to have a deleterious effect on printed circuits and semiconductors. Accordingly, manifold modules having attached ECMs may experience shorter mean times between failures and higher failure rates than comparable manifolds having remote ECMs.

What is needed is an air/fuel intake manifold module wherein the ECM is cooled during operation of the engine to lower thermal exposure to engine heat and to remove heat generated by the ECM itself.

What is further needed is an air/fuel intake manifold module wherein the electrical leads between the ECM and the fuel injectors are cast within the walls of the manifold itself such that an integrated module is formed by installation of the fuel injectors and ECM onto the manifold.

It is a principal object of the present invention to provide an improved air/fuel intake manifold module wherein the ECM is so configured and/or disposed as to be cooled by the passage of air or air/fuel mixture passed through the manifold by the engine.

It is a further object of the invention to provide such a module wherein a case for the ECM is integrally formed into a portion of the manifold, obviating the need for a traditional ECM case.

It is a still further object of the invention to provide such a module wherein the ECM is integrally connected to the fuel injectors via a wiring lead frame cast into the manifold itself to form an integrated air/fuel intake module.

### SUMMARY OF THE INVENTION

Briefly described, an air/fuel intake manifold in accordance with the invention is provided with receiving means for a module logic control means (ECM) wherein the logic control means may be cooled by the passage of air through the manifold. In presently-preferred configurations, the ECM is configured as circuits and chips printed conventionally on a circuit board and protected from contamination by a coating. To facilitate radiative cooling, the ECM preferably is provided without a traditional case. The ECM may be mounted for extension into the air flow path immediately ahead of the main engine throttle and throttle body, which location is preferred for engines wherein hot exhaust gas is recycled directly into the intake manifold behind the throttle body. For other engines, the ECM may be mounted in a well formed in a wall of the manifold and may be further cooled by placement of a heat-sink material between the ECM and the manifold and/or by extension of radiative fins through the manifold wall and into the air stream within the manifold. In other embodiments, the ECM circuit board itself may be extended through a slot in the manifold wall into the air stream; or the circuits may be applied to, or formed directly on, an interior surface of a manifold wall. In a further preferred embodiment, lead wires are cast into a wall of the manifold between pockets for the fuel injector and a pin connector for the ECM such that the control circuits are automatically formed and connected when the fuel injectors and ECM are installed onto the manifold, thus forming a fully integrated air/fuel manifold module.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is a schematic drawing of a prior art engine intake manifold for a six-cylinder engine, having six fuel injectors, showing a master ECM disposed remote from the manifold and connected to the fuel injectors and a throttle sensor by a conventional wiring harness;

FIG. 2 is a schematic drawing of another prior art engine intake manifold, showing an ECM mounted on the manifold and connected in a fashion similar to that shown in FIG. 1;

FIG. 3 is a schematic drawing of a first embodiment of an intake manifold in accordance with the present invention, showing an ECM disposed for cooling in the throat of the intake throttle and connected to the injectors and throttle sensor by an external wiring harness;

FIG. 4 is a schematic drawing of a second embodiment, showing an ECM disposed for cooling in a well in a wall of the intake manifold and connected in a fashion similar to that shown in FIG. 3;

FIG. 4a is a schematic drawing of an embodiment like that shown in FIG. 4 but having a heat sink disposed for cooling in the well beneath the ECM;

FIG. 5 is a schematic drawing of an embodiment like that shown in FIG. 4a but having radiative fins extending for cooling into the manifold interior from the heat sink;

FIG. 6 is a schematic drawing of an embodiment like that shown in FIG. 3 but having the external wiring harness replaced by electrical leads molded into the wall of the manifold;

FIG. 7 is a schematic drawing of an embodiment like that shown in FIG. 4 but having the external wiring harness replaced by electrical leads molded into the wall of the manifold;

FIG. 8 is a schematic drawing of an embodiment similar to that shown in FIG. 7 but having the ECM itself extending for cooling into the interior of the manifold through a slot in the manifold wall;

FIG. 9 is a schematic drawing of an embodiment wherein the printed circuit of the ECM is provided directly on a surface of the manifold, which may be non-planar, either without a circuit board or by lamination of a flexible circuit board to the surface; At and

FIG. 10 is a histogram showing the operating temperatures at two different air flow rates for three embodiments in accordance with the invention compared to a prior art intake manifold.

### DESCRIPTION OF THE PREFERRED EMBODIMENTS

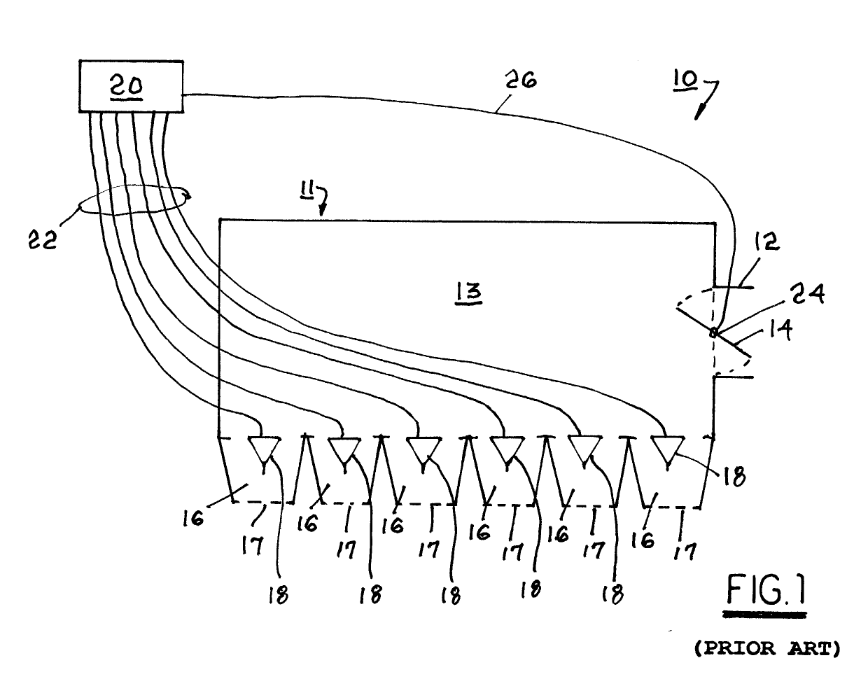

Referring to FIG. 1, a first prior art intake manifold assembly 10 is shown schematically for use conventionally with a six cylinder engine (not shown). Manifold 11 includes a throttle body 12 having a butterfly throttle plate 14 for controlled 2 0 admission of air into an internal distribution chamber 13, and six manifold legs 16 for passage of air from chamber 13 into each of the six cylinders via ports 17. Each of legs 16 is provided with a fuel injector 18 which is supplied with fuel via a conventional fuel rail (not shown) and which dispenses fuel into its respective manifold leg upon a signal from a master electronic engine control module (ECM) 20 via wiring harness 22. The ECM may also receive signals from a throttle position sensor 24 via lead 26 which may or may not be incorporated in wiring harness 22. Numerous other engine functions may be performed by components disposed on an intake manifold, and some of them may require further electrical connections, such as a manifold absolute pressure sensor, fuel pressure sensor, and electronic exhaust gas recirculation sensor. For clarity, these are omitted from discussion herein, although it should be understood that they may be present in an operating example of a manifold, either prior art or novel.

Manifold 11 is typically formed by casting and machining of a metal alloy blank, for example, an aluminum alloy blank. Wiring harness 22 may be attached to the manifold by clips or otherwise. Typically, the electrical connections of the harness wires to the individual injectors are spade connectors requiring human labor for connecting.

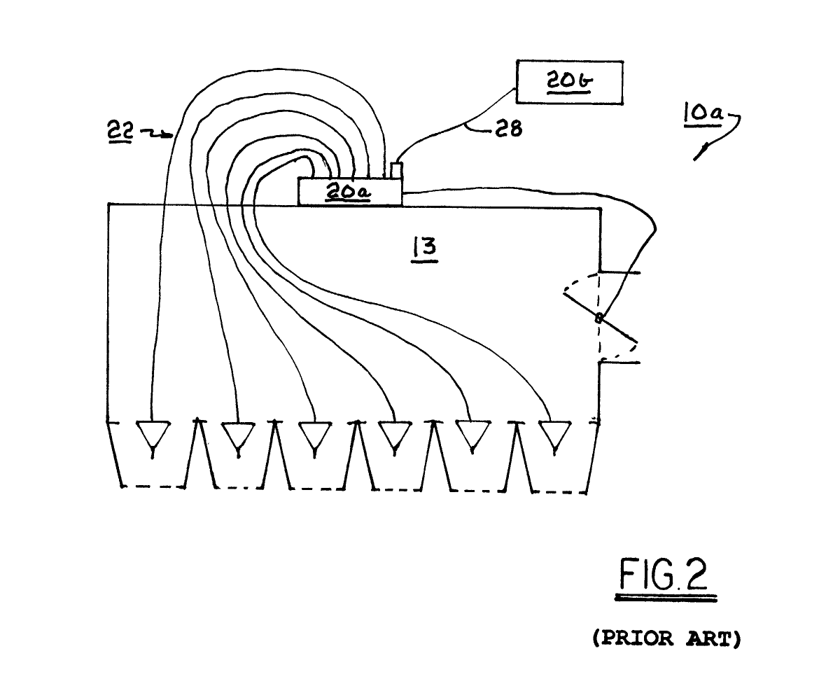

Referring to FIG. 2, another prior art manifold assembly 10a is similar to assembly 10 shown in FIG. 1, but the master ECM 20 has been subdivided into a specific manifold ECM 20a and a residual master ECM 20b controlling engine and vehicle functions other than manifold functions. ECMs 20a, 20b are connected by lead(s) 28. Dividing the master ECM and mounting the manifold ECM on the manifold allows assembly 10a to be assembled and tested off-line as a complete air/fuel module, an important advance in engine technology. However, it is still labor-intensive and component intensive to fabricate. Further, there is no provision for cooling of the circuitry components of ECM 20a.

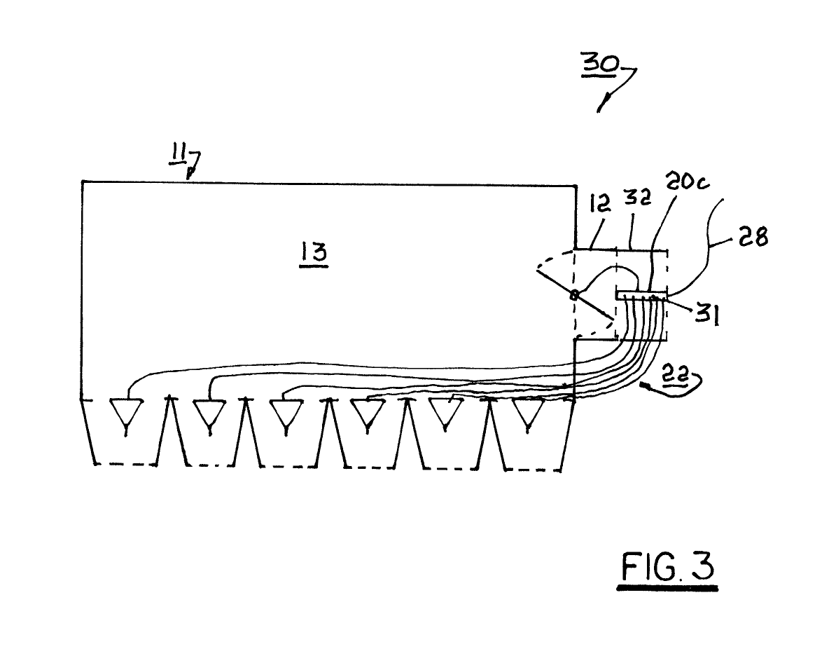

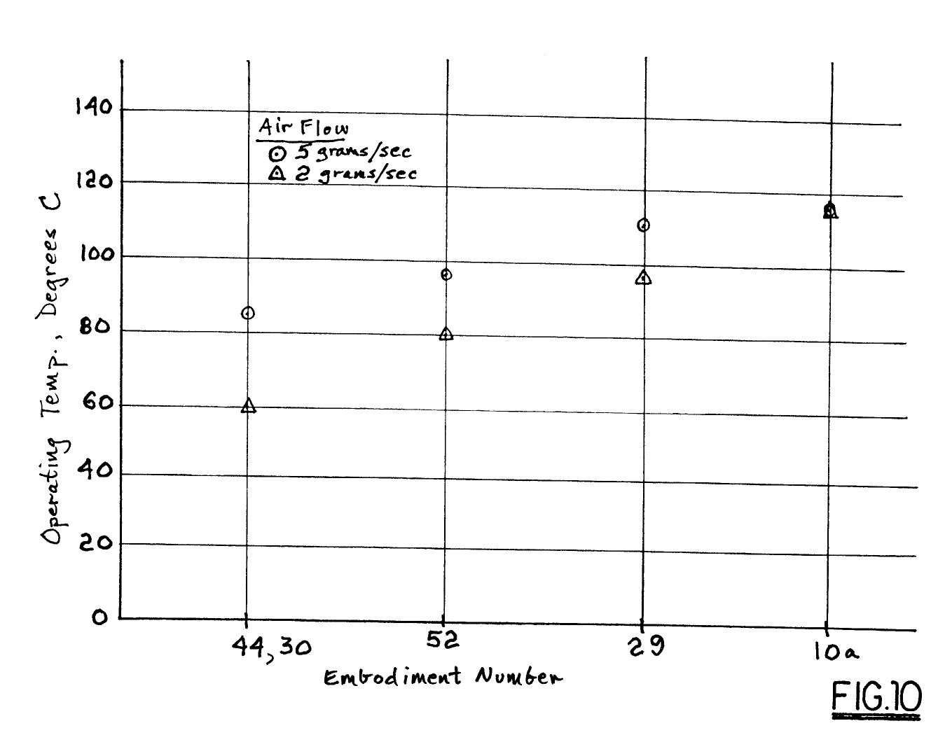

Referring to FIG. 3, a first embodiment 30 of an air/fuel manifold assembly in accordance with the invention is similar in overall appearance and function to prior art assemblies 10, 10a, but with an important improvement. Manifold ECM 20c is mounted in an entry port 32 attached to throttle body 12 and is oriented transverse to the air flow entering throttle body 12. Preferably, ECM 20c comprises an exposed circuit board and pin connector 31 without the protective case typically provided for ECMs 20, 20a, 20b, being coated only with a thin protective coating. ECM 20c is thus Go fully exposed for cooling by air rushing into the manifold. As shown in FIG. 10, the effectiveness of this configuration is demonstrated by its having the lowest ECM operating temperatures of any of the embodiments and prior art devices discussed herein.

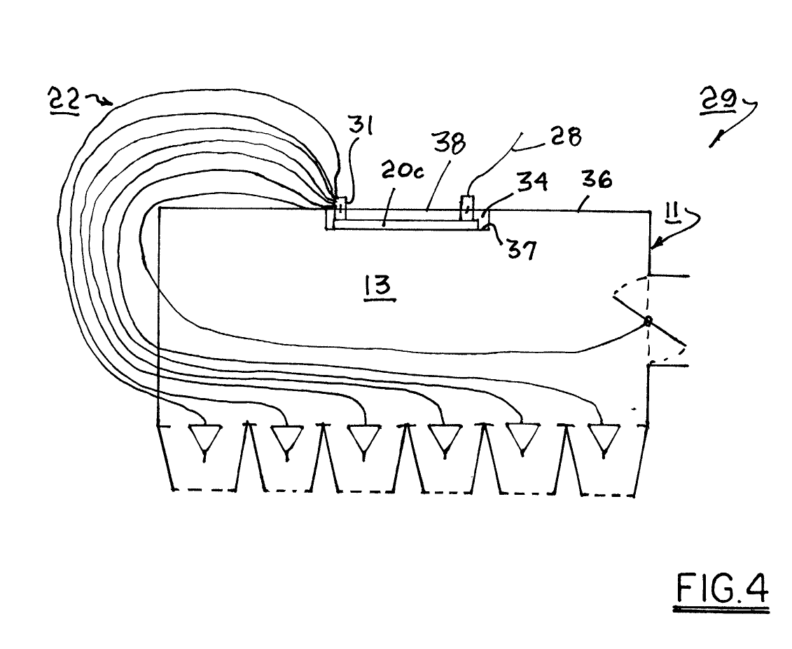

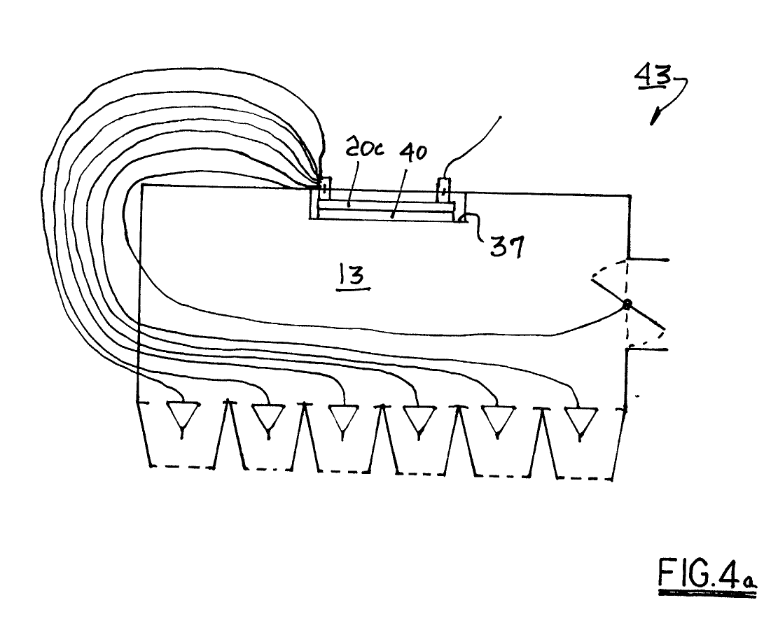

Referring to FIG. 4, in a second embodiment 29, ECM 20c is disposed in a well 34 formed in a wall 36 of manifold 11. ECM 20c is in intimate contact with the bottom 37 of well 34 which is cooled from within by air passing through distribution chamber 13. Well 34 may be provided with a cover 38 if desired. As seen in previous manifold systems, an external wiring harness 22 connects ECM 20c via pin connector 31 with the fuel injectors and throttle sensor.

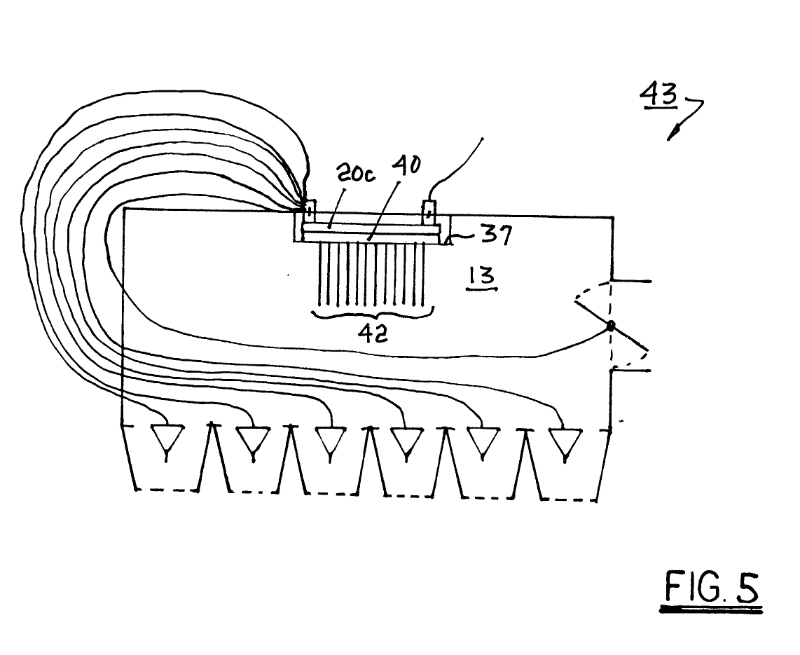

Referring to FIGS. 4a and 5, showing a third embodiment 43, cooling of ECM 20c may be enhanced by installing a heat sink 40 between the ECM and the bottom 37 of the well. The surface of heat sink 40 may be specially configured to conform the heat sink to specific heat-generating areas of the circuit board in ECM 20c, to transmit heat efficiently from those areas into manifold 11. The heat sink is preferably formed of a highly conductive metal, for example, aluminum. As shown in FIG. 5, heat sink 40 may be made still more efficient by providing it with fins 42 which extend through well bottom 37 into chamber 13.

Historically, manifolds have been formed by casting of metal alloys. More recently, manifolds are known which are injection molded of heat resistant thermoplastic polymers, for example, Nylon 6-6, at considerably savings in cost and weight. The dielectric nature of such plastics presents an opportunity for further modularizing air/fuel intake manifolds through incorporation of the requisite wiring into the structure of the manifold itself via overmolding of lead frames in the process of forming the manifold, eliminating external wiring harnesses and the human labor required to connect them. Preferably, the lead frames terminate in pin connectors such that the functional electrical components to be added to the manifold, such as fuel injectors and throttle sensors, are automatically connected by plugging them into appropriately configured receivers formed in the manifold. Such installation and assembly can be done readily by machines at great savings in labor cost. An integrated manifold module assembled and tested by machine is very cost-effective and can be immediately ready for use: this manufacturing technique is known in the art as “plug-and-play.”

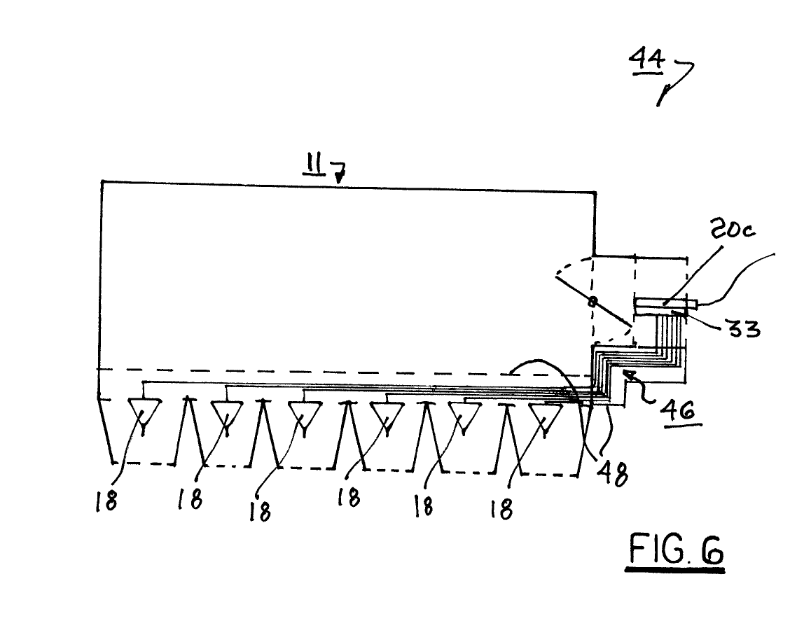

Referring to FIG. 6, a first plug-and-play embodiment 44 is similar in configuration to embodiment 30 shown in FIG. 3. However, a lead frame 46 containing all required electrical leads for connecting ECM 20c with fuel injectors 18 is molded into a wall 48 of manifold 11. Lead frame 46 terminates at a first end in a pin connector 33 for mating with pin connector 31 on ECM 20c, and at individual pin connectors (not shown in detail) at sockets for receiving the individual fuel injectors. Alternatively, pin connector 33 may be molded into throttle body 12 such that ECM 20c may be plugged directly into the throttle body. Thus, all mechanical, electrical, and electronic components are integrated into a single, simple air/fuel module.

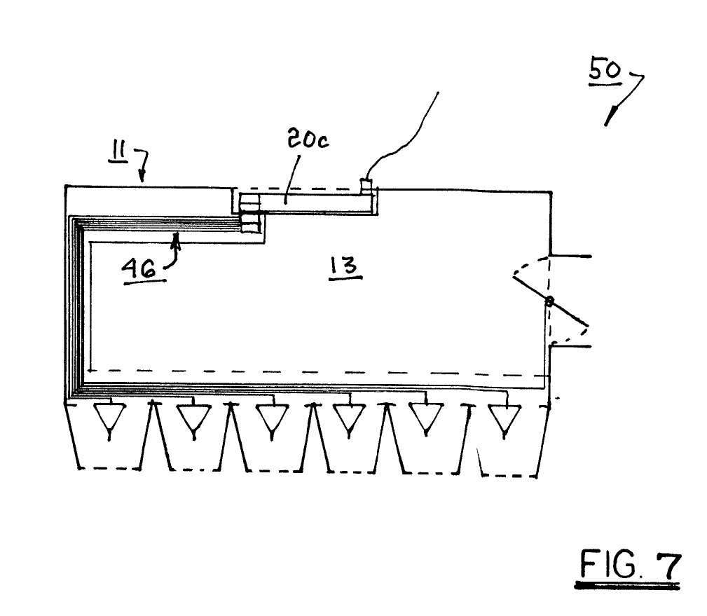

Referring to FIG. 7, a second plug-and-play embodiment 50 is similar in configuration to embodiment 29 shown in FIG. 4. However, as in embodiment 44, a lead frame 46 is molded into a wall of the manifold, thus providing an integrated air/fuel module.

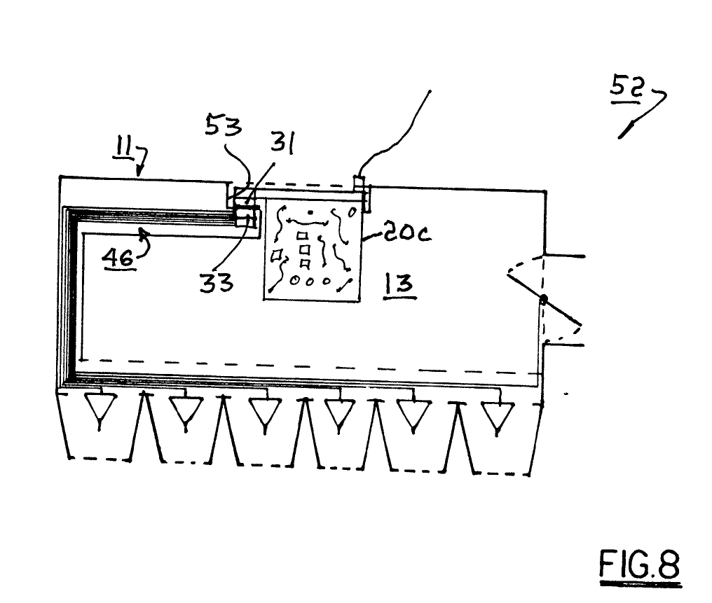

Referring to FIG. 8, a third plug-and-play embodiment 52 includes an ECM 20c disposed through a slot 53 formed in a wall of manifold 11 and extending for cooling into chamber 13. ECM 20c is provided with a pin connector 31 for mating with pin connector 33 of lead frame 46, again to form an integrated air/fuel module.

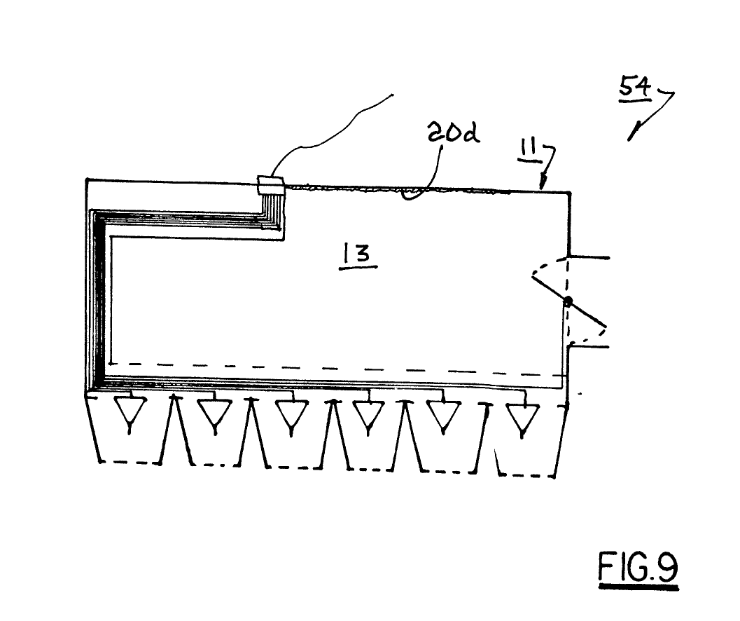

Referring to FIG. 9, a fourth plug-and-play embodiment 54 includes an ECM 20d either formed directly on an inner (shown) or outer (not shown) surface of a wall of manifold 11, as by circuit board printing techniques, or laminated to either of such surfaces. Flexible circuit “boards” are known in the art and may be conformably laminated to manifold surfaces, including non-planar surfaces.

Referring to FIG. 10, significantly cooler operation is experienced by the ECMs of air/fuel modules in accordance with the invention in comparison with ECM 20a of prior art manifold assembly 10a (FIG. 2). Under engine test conditions, ECM 20a has an operating temperature of 115° C. at both high and low air flows through the manifold, showing that no cooling of the surface-mounted ECM is taking place. ECM 20c of embodiment 29 (FIG. 4) operates at a temperature between about 95° C. and 110° C., depending upon the volume of air being drawn through the manifold, showing that air cooling of the ECM is occurring. ECM 20c of embodiment 52 (FIG. 8) operates at a temperature between about 80° C. and 95° C., and ECM 20c of embodiment 44 (FIG. 6) operates at a temperature between about 60° C. and 85° C.

Thus it is seen that integrated manifold modules in accordance with the invention can provide very large reductions in operating temperatures for the ECM. In addition to extending the life and enhancing the reliability of the ECM, lowered operating temperatures permit significant reductions in the size of the ECM itself, an important benefit in the crowded underhood environment of a modern vehicle.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. An air/fuel manifold assembly for an internal combustion engine, comprising:
a) an intake manifold for supplying flowing air therethrough to firing chambers of said engine; and
b) an engine control module disposed on said manifold such that heat may be extracted from said module by the passage of air through said manifold.

2. A manifold assembly in accordance with claim 1 wherein said assembly further includes a throttle body attached to said manifold and wherein said engine control module is mounted in said assembly upstream of said throttle body in said air flow.

3. A manifold assembly in accordance with claim 1 wherein said engine control module is protected solely by a coating.

4. A manifold assembly in accordance with claim 1 wherein said manifold is formed to have a well in a wall thereof and wherein said engine control module is disposed in said well.

5. A manifold assembly in accordance with claim 4 further comprising a heat sink disposed with said engine control module in said well.

6. A manifold assembly in accordance with claim 4 wherein said well has slots formed in a bottom thereof, and wherein said engine control module has radiative fins extending through said slots into an interior chamber of said manifold for cooling by said air flow.

7. A manifold assembly in accordance with claim 5 wherein said well has slots formed in a bottom thereof, and wherein said heat sink has radiative fins extending through said slots into an interior chamber of said manifold for cooling by said air flow.

8. A manifold assembly in accordance with claim 1 wherein a wall of said manifold has an opening therein and wherein said engine control module extends through said opening into an interior chamber of said manifold for cooling by said air flow.

9. A manifold assembly in accordance with claim 1 wherein said engine control module includes a flexible circuit board conformably laminated to a surface of is said manifold.

10. A manifold assembly in accordance with claim 1 wherein said engine control module includes an electronic circuit deposited directly on a surface of said manifold.

11. A manifold assembly in accordance with claim 1 further comprising electrical leads disposed within a wall of said manifold for connecting said engine control module to electrical components of said assembly.

12. A manifold assembly in accordance with claim 11 wherein said electrical leads terminate in a pin connector for matably connecting with said engine control module.

13. A manifold assembly in accordance with claim 1 wherein said manifold is formed of material selected from the group consisting of metal alloy and thermoplastic polymer.

14. A manifold assembly in accordance with claim 13 wherein said polymer is a nylon.

15. An air/fuel manifold assembly for an internal combustion engine, comprising an engine control module protected solely by an integral coating thereupon.

16. An air/fuel manifold assembly for an internal combustion engine, said assembly including an engine control module and comprising electrical leads disposed within a wall of said manifold.

17. A manifold assembly in accordance with claim 16 wherein said electrical leads terminate in a pin connector for matably connecting with said engine control module.

18. An internal combustion engine, comprising an air/fuel manifold assembly having
an intake manifold for supplying flowing air therethrough to firing chambers of said engine; and
ii) an engine control module mounted on said manifold such that heat may be extracted from said module by the passage of air through said manifold.
